(19) United States
(12) Patent Application Publication
(10) Pub. No.: US 2024/0395045 A1
(43) Pub. Date: Nov. 28, 2024

(54) Device to Capture High Resolution Images of the Wheel Tread on a Moving Train

(71) Applicant: Edward Joseph Buschelman, Jacksonville, FL (US)

(72) Inventor: Edward Joseph Buschelman, Jacksonville, FL (US)

(21) Appl. No.: 18/200,909

(22) Filed: May 23, 2023

(51) Int. Cl. G06V 20/50; B61K 9/12

(52) U.S. Cl. CPC G06V 20/50; B61K 9/12

(57) ABSTRACT

As a train passes over an array of cameras and lights that have been positioned between the rails of a train system, images are captured of the wheel tread. The number of cameras that will be used in the array may vary depending on the end user of the train system and its specific requirements. Software will capture the images of the portion of each wheel tread and reassemble the images in a linear format. The linear format for each wheel tread will provide an image that can be easily analyzed by the end user of the train system.

### A. FIELD OF THE INVENTION

Trains move on a set of rails equally spaced that form tracks. The wheels of the train, which are circular and specifically designed for use on railway tracks, are placed on the rails and permit movement of the train along the rails. The wheel tread is the portion of the wheel that contacts the rail upon which the train will travel. It is important to ensure that the wheel tread maintains its integrity to prevent any interruption of the train as it moves on the rails.

Each camera that is used in the current device will capture a predetermined section of the wheel tread as it moves on the rails. The entire array of cameras will capture images on the entire wheel treat. Software will stich each of the sections to be depicted as a flat surface so that the operator or artificial intelligence can identify any possible defects on the wheel tread.

### B. PRIOR ART

In the device and method to trigger an array of lights and cameras to capture resolution images of the moving wheel tread on the moving train. There are references in the prior art which detect wheel damage and specifically a representative example of this can be found at Berndt U.S. Pat. No. 4,781,060. In Berndt, the system is characterized by a manually expanding accelerometer which is joined at a rail underneath its head. This does not use lights and cameras to capture the image of the wheel tread.

Another example of the prior art can be found in Hershey U.S. Pat. No. 5,433,111. This reference uses motion sensors as opposed to lights and cameras. This application is different than the prior art because it utilizes an array of lights and cameras, which are not found or contemplated by Hershey. Other examples of the prior art include Vanaki U.S. Pat. No. 5,793,492, Gronskov U.S. Pat. No. 6,416,020, Mian U.S. Pat. No. 6,523,411, Mesher U.S. Pat. No. 11,142,230 and Mesher U.S. Pat. No. 11,137,713. None of the prior art references employ a series of lights and cameras to capture images of the wheel treads as the train moves along the rail path.

### BRIEF SUMMARY OF THE INVENTION

In the instance of a train, which moves at a relatively high speed and typically involves remote locations, it is important to inspect the wheel tread. A wheel tread is the part of the train that contacts the rails on which the train will move. Damage to the wheel tread can cause issues with ride quality and decrease the nominal lifespan of other rotating components such as bearings. Significant damage to a wheel tread can cause a derailment in which there is no longer contact between the wheel tread and rail and may result in property damage, ecological disaster, and even severe physical injury including death.

It is important to maintain the function of the wheel tread and to alert the user of the train system about defects in the wheel tread. Damage to wheel tread is to be expected and must be monitored.

In this application an array of cameras with associated lights will be placed on the ground either between the rails or on the outside of the rails. As the train approaches the array of lights and cameras the array of lights will activate. The activation and control of the lights and cameras is managed by dedicated software and hardware not specific to this patent.

The array of lights is most likely an array of LED light produced in the visible spectrum. The cameras in the system are area scan cameras operating in the visible spectrum.

As the wheel tread moves past a designated location on the rail, the array of cameras will sequentially capture high resolution images of the wheel tread as it passes by that point. Each of the cameras will capture a predetermined section of each wheel tread and the software that is part of this system will reassemble the images of the wheel treads. The software will display the images in a linear format so that the operator can easily inspect the images for defects of the wheel tread.

The number of lights and cameras which are associated with the array may vary depending on the specific train system involved and any specific regulations. In addition, the positioning and position of the array of lights and cameras will vary in a particular application to ensure the camera and illumination field of view is not obstructed by other components of the train assembly or not effected by glare.

### BRIEF DESCRIPTION OF THE DRAWINGS

FIG. 1 is a plan view of a nominal single light and camera configuration for one image.

FIG. 2 is an elevation view of a nominal array of lights and cameras to capture a series of images.

FIG. 3 is a plan view of a nominal array of lights and cameras to capture a series of images.

FIG. 4 a schematic of the components of the system.

### NUMBERING REFERENCE

1 Train
5 LED Lights
10 Area scan Cameras
12 Wheel
15 Wheel Tread
20 Composition Software
25 Rail

### DETAILED DESCRIPTION OF THE EMBODIMENTS

Technology is used to measure the speed of a train 1 as it passes over sections of tracks. The speed of the train is used by the composition software 20 to activate the array of lights and cameras to capture high speed images of the wheel treat. Trains are placed on parallel rails 25 and follow a predestined course of travel. The wheels 12 of the train are circular and rest on the rails 25; the wheels 12 will rotate as the train moves on the rails. The portion of the wheel 12 that contacts the rails 25 is the wheel tread 15.

It is important to inspect the wheel tread to ensure that the wheel tread allows proper rotation of the wheel. There are many reasons that a wheel tread may become damaged including but not limited to excessive braking, and debris on the rails to name just a few of the causes for damages to the wheel tread. If there are any defects to the wheel tread, it may lead to inefficient travel of the train or a catastrophic failure of the travel of the train.

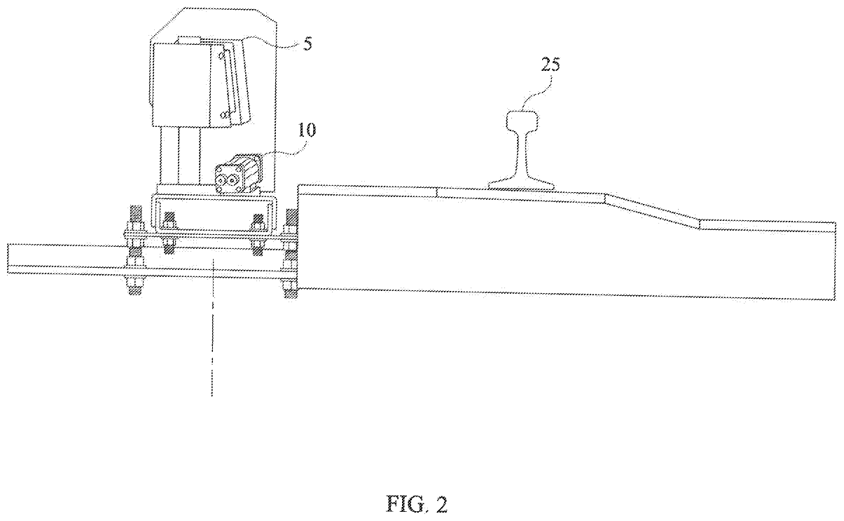

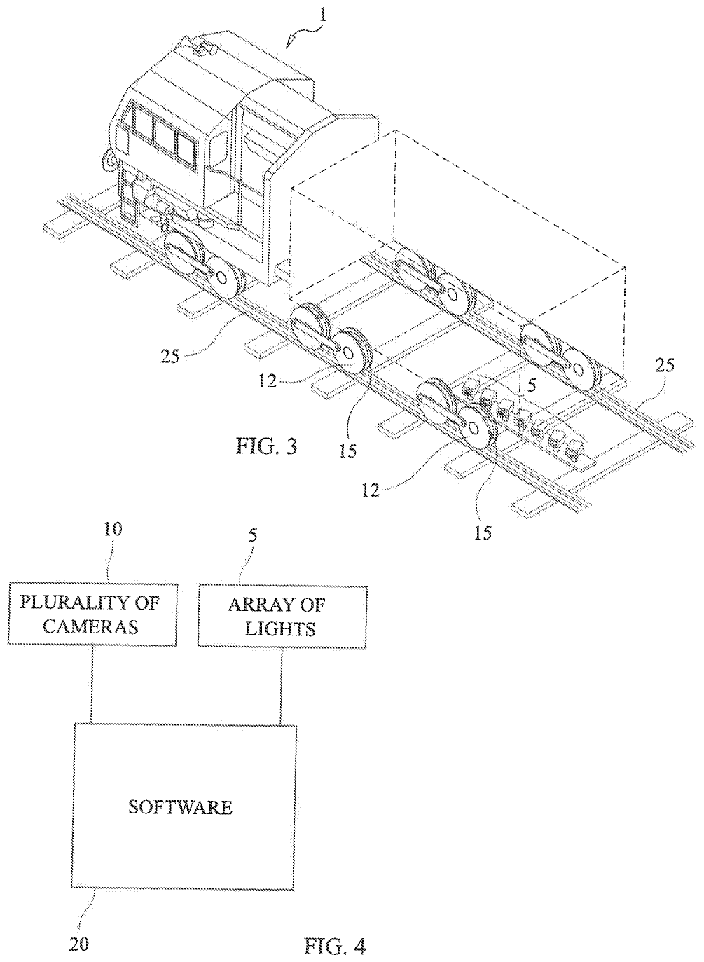

With this device an array of lights 5 are positioned on the ground either between the rails or on the outside of the rails. A corresponding plurality of cameras 10 that will capture the images of the wheel tread will be positioned proximate to the lights in the array as depicted in FIGS. 2 and 3.

Composition software 20 will control the activation of the array of lights and the timing of the cameras to capture high resolution images of the entire wheel tread. Each Camera 10 will capture a preset portion of the wheel tread and generate an image file. The full array of cameras will capture the entire surface of the wheel tread. Each of the cameras in the array will generate an image files for each section of the wheel tread. Composition software 20 will assemble the multiple image files into one composite image representing the full wheel tread 15.

The lights are lights 5 that can turn on and off quickly and provide adequate illumination to enable the cameras to capture high resolution image of the wheel tread. The lights are likely LED lights that have the advantage of turning on an off quickly. Proximate to the array of lights are a plurality of area scan cameras, 10. Dedicated Hardware and composition Software 20 will activate the array of lights 5 and array of cameras 10 as the train approaches a predetermined location on the rails. Separate software calculates the speed of the train.

The plurality of area scan cameras which when activated by the dedicated hardware and composition software 20, will take predetermined high-resolution images of the underside of the train car including images of the wheel tread 15. The composition software 20 will reform the images of the section of wheel tread captured by each camera in a linear format to enable the end user to quickly assess whether there has been any damage to the wheel tread.

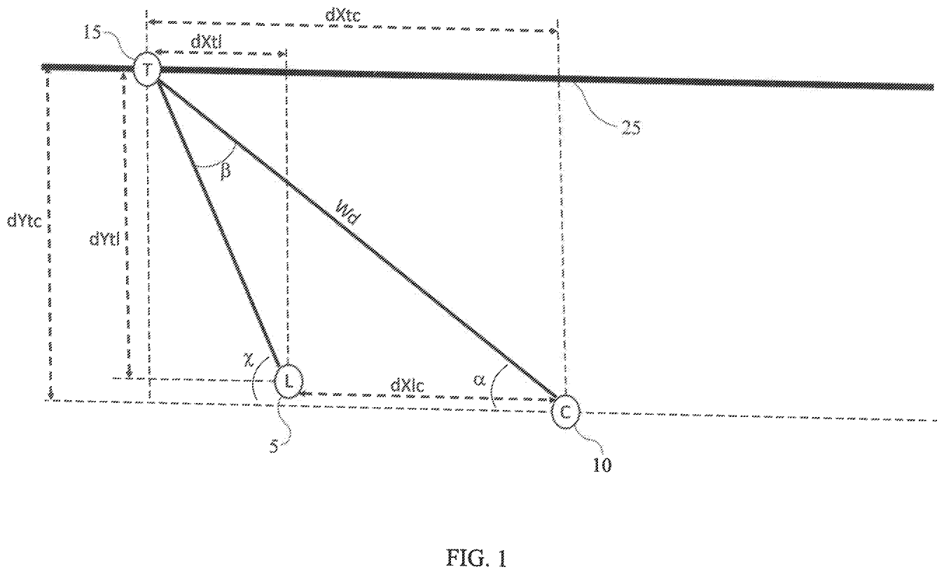

The use of area scan cameras is important to allow a broader width image. The lights and cameras are configured at an angle relative to the train to provide the best possible quality image and mitigate the effects of reflection and glare such as depicted in FIG. 1. The cameras and lights are offset from each other and positioned at an angle relative to the train to capture the best image and minimize reflection and glare.

While the embodiments of the invention have been disclosed, certain modifications may be made by those skilled in the art to modify the invention without departing from the spirit of the invention.

The inventor claims:

1. A device to capture high resolution images of the wheel tread of a moving train which is comprised of:
an array of cameras,
wherein the array of cameras are positioned on the ground at a predetermined location,
wherein the array of cameras are positioned at an angle relative to the wheel tread,
wherein each camera in the array of cameras capture a specified part of the wheel tread,
wherein the array of cameras will capture the full three hundred and sixty degree image of the wheel tread,
a plurality of lights,
wherein the plurality of lights are positioned at an angle relative to the wheel tread,
wherein the plurality of lights is positioned proximate to each light in the array of cameras,
composition software,
wherein the composition software reforms individual images of each of the images that are captured by the cameras,
wherein the images are displayed in a linear format.

2. A device to capture high resolution images of the wheel tread of a moving train as described in claim 1, wherein the cameras are area scan cameras.

3. A device to capture high resolution images of the wheel tread of a moving train as described in claim 1 wherein the lights in the array of lights are LED lights.

4. A device to capture high resolution images of the wheel tread of a moving train as described in claim 1 wherein the array of lights are positioned on the ground between the rails.

5. A device to capture high resolution images of the wheel tread of a moving train as described in claim 1 wherein the array of lights are positioned on the ground on the outside of the rails.
